(19) United States
(12) Patent Application Publication
(10) Pub. No.: US 2018/0089925 A1
(43) Pub. Date: Mar. 29, 2018

(54) Vending Profits

(71) Applicant: Mendi Salijeski, Sherman, TX (US)

(72) Inventor: Mendi Salijeski, Sherman, TX (US)

(21) Appl. No.: 15/706,731

(22) Filed: Sep. 17, 2017

Related U.S. Application Data
(60) Provisional application No. 62/399,512, filed on Sep. 26, 2016.

(51) Int. Cl. G07F 17/00; G07F 9/10; B25J 9/00

(52) U.S. Cl. CPC G07F 17/0078; B25J 9/00; G07F 9/105

(57) ABSTRACT

The portable snack vending apparatus comprises a display module with one or more cylindrical containers positioned in a multi-layered stacked configuration, wherein each container is configured to store the predefined snack and disperse the snack based on a user input to a mixer section via a dropping funnel. A control module comprising an electronic interface with a microcontroller to receive a payment from a user and one or more icons to allow the user to selectively choose the snack from one or more cylindrical containers positioned in the display module. A packaging module comprising a robotic assembly configured to wrap and seal the snack from the mixer section in a bag, thereby the wrapped bag is dispensed into a serving receptacle for the user's consumption.

### BACKGROUND OF THE INVENTION

### A. Technical Field

The invention disclosed herein generally relates to a vending apparatus. More particularly, the invention disclosed herein relates to a snack vending apparatus for providing a mixture of warm nuts and other condiments.

### B. Description of Related Art

Snacking is something inevitable for individuals whether at work or at home as it helps them to maintain required energy levels throughout the day. Pre-packaged products available from vending machines vary in freshness. A mix of nuts with an assortment of other condiments has proved to be a very pleasurable, flavorsome, and nutritious refreshment for countless number of people. The mix can contain a selection of nut products ranging from peanuts, walnuts, cashews, hazelnuts, pecans, etc. Currently, snacks are provided by most vending machines at room temperature or chilled. Often the product is stored in a warehouse or a service truck before placement in the vending machine. The product may be cold and not palatable to a consumer. An apparatus, which preheats or warms the product to be dispensed to the consumer, is required. This collection of nut products benefits from a flavor enhancing roasting at moderate temperature. The fresher the roasting, the better the flavor of the nuts.

Moreover, traditional snack vending machines dispense only packaged products. They do not provide a consumer options to select an assorted variety of products from the vending machine. However, vending machines are not known for their ability to provide such an appetizing arrangement for the hungry consumer looking for something fresh and different. A typical vending machine provides the usual premix in a pre-packaged never changing assortment. While this can be somewhat satisfying, it provides no variety and can eventually become boring and routine to anyone utilizing the vending machine repeatedly. Roasting a selected nut product on the spot and mixing a chosen assortment of condiments destined for the hungry consumer has been just overlooked in the vending machine market. An apparatus, which allows a consumer to select a customized mix of nuts or condiments, is required. This provides an option to the user to experiment with the available products in the vending machine. For example, mixing warm nuts with dried fruit, candies, sesame sticks, etc., provides a user freshness and improvisation to obtain a fresh snack combination.

Hence, there is a long felt but unresolved need for an apparatus, which allows a consumer to select a customized mix of nuts or condiments. Furthermore, there is a need for an apparatus, which preheats or warms the snack combination to be dispensed to the consumer.

### SUMMARY OF THE INVENTION

This summary is provided to introduce a selection of concepts in a simplified form that are further disclosed in the detailed description of the invention. This summary is not intended to identify key or essential inventive concepts of the claimed subject matter, nor is it intended for determining the scope of the claimed subject matter.

The portable snack vending apparatus, disclosed herein, addresses the above-mentioned need for an apparatus, which allows a consumer to select a customized mix of nuts or condiments. Furthermore, the invention addresses a need for an apparatus, which preheats or warms the snack to be dispensed to the consumer. The portable snack vending apparatus comprises a display module having one or more cylindrical containers positioned in a multi-layered stacked configuration, wherein each container is configured to store a predefined snack and disperse the snack based on a user input to a mixer section via a dropping funnel. A control module comprising an electronic interface with a microcontroller to receive payment from a user and one or more icons to allow the user to selectively choose the snack from one or more cylindrical containers positioned in the display module.

In other embodiments, a packaging module in the portable snack vending apparatus comprises a robotic assembly configured to wrap and seal the snack from the mixer section in a bag, wherein the wrapped bag is dropped into a serving receptacle. The snack vending apparatus offers an approach to satisfy the need for fresh roasting of selectable assorted nut products and the ability to mix these products at the point of sale with condiments such as dried fruit or candies.

In another embodiment, the cylindrical container containing the snack is made from a clear acrylic material so that the consumer could make their choice with a visual reference. If the customer has selected to roast the nuts the heating element is activated for predetermined amount of time appropriate for the selection made. The heating element also serves as a collection bin and so if roasting is not selected then the oven will not get activated. Once the roasting process is complete, the portable snack vending apparatus moves the snack to the mixer section for final mixing. A colorful attractive bag is disposed via a transparent window at a bottom section of the serving receptacle in the portable snack vending apparatus.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and structures disclosed herein. The description of a method step or a structure referenced by a numeral in a drawing is applicable to the description of that method step or structure shown by that same numeral in any subsequent drawing herein.

FIG. 1 exemplarily illustrates a front elevation view of a portable snack vending apparatus.

FIG. 2 exemplarily illustrates a rear elevation view of the portable snack vending apparatus.

FIG. 3 exemplarily illustrates a right-side view of the portable snack vending apparatus with a front door.

### DETAILED DESCRIPTION OF EMBODIMENTS

A description of embodiments of the present invention will now be given with reference to the Figures. It is expected that the present invention may be embodied in other specific forms without departing from its spirit or essential characteristics. The described embodiments are to be considered in all respects only as illustrative and not restrictive.

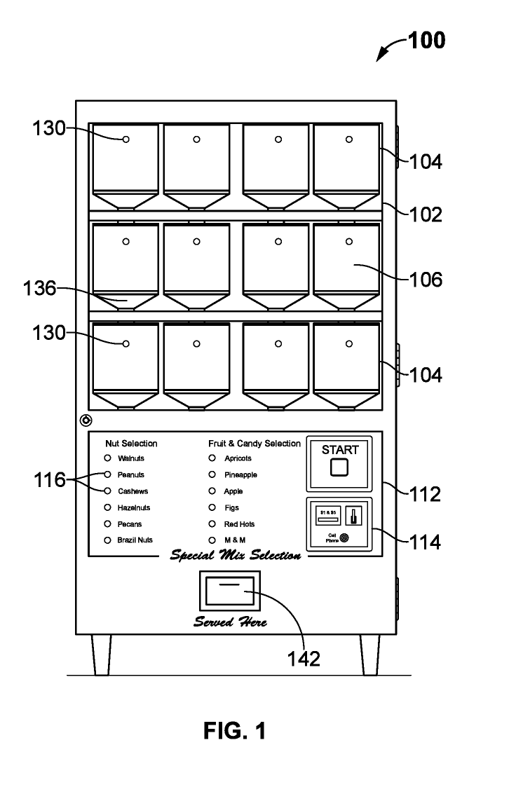

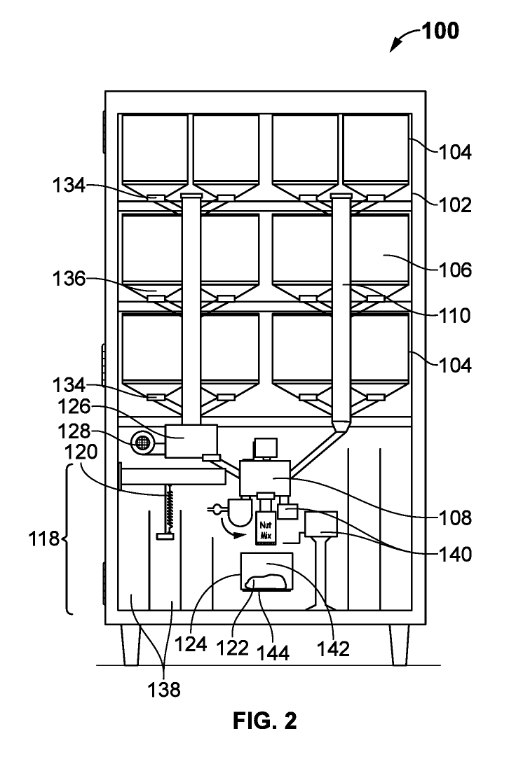

Referring to FIG. 1, a front elevation view of a portable snack vending apparatus 100 is illustrated. Referring to FIG. 2, a rear elevation view of a portable snack vending apparatus 100 is illustrated. The portable snack vending apparatus 100 is configured to allow a consumer to select a customized mix of nuts or condiments as well as to preheat or warm the snack to be dispensed to the consumer. The portable snack vending apparatus 100 disclosed herein, comprises a display module 102 having one or more cylindrical containers 104 positioned in a multi-layered stacked configuration, wherein each container 104 is configured to store a predefined snack 106 and disperse the snack 106 based on a user input to a mixer section 108 via a dropping funnel 110. A control module 112 comprising an electronic interface 114 with a microcontroller to receive payment from a user and one or more icons 116 to allow the user to selectively choose the snack 106 from one or more cylindrical containers 104 positioned in the display module 102. The portable snack vending apparatus 100 further comprises a packaging module 118 with a robotic assembly 120 configured to wrap and seal the snack 106 from the mixer section 108 in a bag 122, wherein the wrapped bag 122 is dropped into a serving receptacle 124. Preferably, the apparatus 100 is configured to have 12 cylindrical containers 104 holding various nuts and dried fruits, which are dispensed under computer control, into the bag 122.

In one embodiment, when the user begins the process by clicking the START button in the control module 112 and chose the snack 106 such as a nut, a fruit or a candy from the available list of icons 116. The microcontroller in the control module 112 receives the choice of selection made by the user from the available list of snacks 106. The control module 112 comprises a multi-color touchscreen display to guide the user to selectively choose the snack from the cylindrical containers 104 positioned in the display module 102. The portable snack vending apparatus 100 further comprises a heating section 126 configured to selectively heat the predefined snack 106 selected by the user. In some embodiments, the heating section is an oven, or any known heating device. The predefined snack 106 is at least one of a peanut, a walnut, a cashew, a hazelnut, a pecan, an almond, a chestnut, a palm nut, a candle nut, a pistachio, a pine nut, a dried fruit, a candy, a sesame stick, a gumdrop, a jelly and a mint. However, any other snack 106 depending on the likes of the consumer could be loaded in the cylindrical containers 104, without deviating from the aspects of the present invention.

The heating section 126 depending on the selection of the user, is configured to selectively roast at least one of a nut and a mixed snack 106. The heating section 126 is activated by the user with a click of a button in the control module 112. If only nuts are selected as the snack 106 by the user, the apparatus 100 is configured to serve the nuts at room temperature, or air heat the nuts to a lower, yet warm temperature, or could air heat the nuts to a roasting temperature using a blower 128. This option is programmed into the apparatus 100 and is part of the icon/menu driven selection process. Alternatively, the apparatus 100 allows the actual heating temperature of the nuts to be selected from a series of displayed temperatures ranging from 100° F. (warm) to 160° F. (roasted). The apparatus 100 will then engage the roaster and heat until the nuts reach the selected temperature before dropping them into the mixer section 108. Once this selection process is completed, the user is required to start the payment process via the electronic interface 114. In case if the user does not require to heat the snack 106, the heating section 126 could act as the dispenser.

In another embodiment, the portable snack vending apparatus 100 comprises a light indicator 130 disposed in each of the cylindrical containers 104 positioned in the display module 102 to visualize the snack 106 selected by the user. For example, an LED light indicator 130, exemplarily illustrated in FIG. 1. If the selection is incorrect, the selection process will be showing error wherein it is corrected by the user. The user could select via touch screen display for any one of the displayed snack 106. For example, if cashews are selected, so the microcontroller in the control module 112 sets the LED light indicator 130 in front of the cashews ON. This helps the user to visually confirm the ordered snack 106. The user could also select any, several, or all of the fruits or candies to mix with the nuts. In preferred embodiments, the cylindrical container 104 is made from a clear acrylic material to visualize the stored predefined snack easily.

In a different embodiment, the cylindrical container 104 is refilled with the predefined snack 106 manually by unlocking a front door of the display module 102 by the user, or automatically by any robotic arms, or automatic timer based predefined snack filling apparatus. The operator and the user could look through the front door 132 to see if the translucent cylindrical container 104 is empty. The apparatus 100 is also configured to warn the service technician that one or more cylindrical containers 104 are empty and need re-filling to keep the apparatus 100 working with minimal interruption. The portable snack vending apparatus 100 also includes security features in the microcontroller to ensure the operator is notified in at least one of a scenario such as if the apparatus 100 is tilted too far, the front door 132 is opened without inputting this week's service code, the apparatus 100 is unplugged, or any of the cylindrical container apparatus 100 requires re-filling.

In preferred embodiments, the user is prompted to make the payment via the electronic interface 114 in the control module 112. The electronic interface 114 is configured to receive payment from the user via at least one of a legal tender, a credit card, a debit card, a NFC, a Wi-Fi, a digital payment and a Bluetooth capability which also allows for easy payment for the selected snack from the portable snack vending apparatus 100. Preferably, the user could pay at least in one of three ways such as $1 or $5 bills, use of the credit or debit card, or use the cell phone. The credit/debit and NFC capable cell phone transaction is completed using the system Wi-Fi connection and if the WIFI connection is lost, the transactions could be completed via the cellular phone link.

In another embodiment, the micro-controller then fills the order, based upon the saved inputs, once the payment is made. The microcontroller in the control module 112 is configured to process an input received from the user and activate a solenoid valve 134 based on user input to disperse the predetermined amount of the snack 106 from the cylindrical container 104 to the mixer section 108. The cylindrical container 104 comprises a conical base and a sloping tube section 136 to disperse the snack 106 to the dropping funnel 110 which in turn leads to the mixer section 108. Preferably, the cylindrical container 104 is made from a food grade polycarbonate material. The mixer section 108 is configured to selectively mix at least one of the nut and the condiment based on user's selection from the cylindrical containers 104 positioned in the display module 102. In an exemplary embodiment, the microcontroller could be programmed for each purchase in such a way that 1 cup of nuts will be mixed with ½ cup servings of various fruits and/or candies for the mixing ratio of the snack. The apparatus 100 could be programmed in each serving by the operator by changing the measuring cup size in the solenoid valve 134.

In another embodiment, the robotic assembly 120 in the packaging module 118 is configured to retrieve the bag 122 from a storage bin 138 via one or more arms to wrap the predetermined amount of snack 106 from the mixer section 108. Preferably, the bag 122 is picked up using a vacuum lifter from the storage bin 138 whereupon it is transferred to the robotic arm, which in turn, opens the bag 122, rotates it, and slips it onto the mixer section 108. Tightly compressed bags 122 are stored flat in the storage bin 138, in two stacks, and are retrieved using the vacuum pick up. Consecutively, the other robotic arm grips the bottom of the bag 122, preventing it from slipping off the mixer section 108 when the mixed snack 106 is dropped into the bag 122. Once filled, the robotic arm is configured to move the wrapped bag 122 through a thermal sealer 140 and drop into the serving receptacle 124. The serving receptacle 124 is located near the mixer section 108.

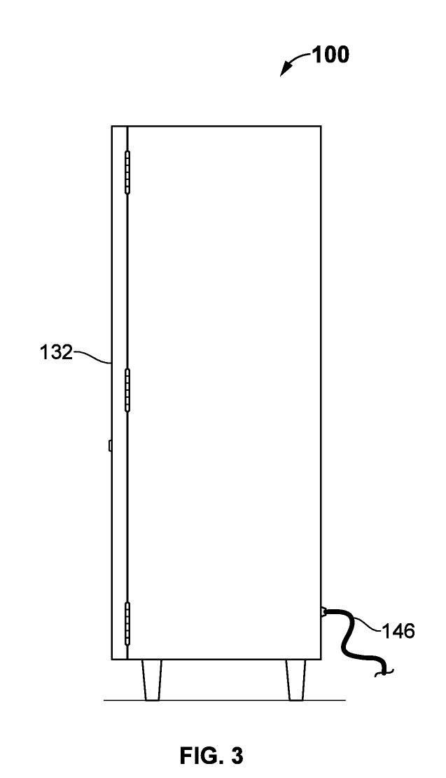

The portable snack vending apparatus 100 further comprises a transparent window 142 at a bottom section of the serving receptacle 124. The transparent window 142 is configured to have a spring loaded continuous hinge assembly 144 to automatically close once the bag 122 is retrieved from the serving receptacle 124. The hinge assembly 144 is durable and support the transparent window 142 easily for many years of service without degradation. The food grade plastic window 142 is transparent so the user could see, when the sealed bag 122 is dropped into the serving receptacle 124. The transparent window 142 is virtually indestructible yet is easy to clean and maintain. Further, logo and delivery instructions are painted on for durability. Referring to FIG. 3, a right-side view of the portable snack vending apparatus 100 with a front door 132 is illustrated. The portable snack vending apparatus 100 also comprises a connector assembly 146 to power the apparatus 100 using an external power source. In some preferred embodiments, the apparatus 100 is powered with a 120 VAC dedicated circuit, which is required by the multiple devices inside the cabinet.

In different embodiments, manufacturing of the modules and components of the apparatus 100 are disclosed. The apparatus 100 includes a housing or a cabinet to cover the three modules such as the display module 102, the control module 112 and the packaging module 118. This housing is manufactured from various thicknesses of sheet steel, which has been cut from large rolls of sheet stock on a computer controlled water jet-machining center. The housing is made from 20-gauge (0.030″) material, the working surfaces are made from 18-gauge (0.040″) material, and the internal support structures are made from 12-gauge (0.080″) material. The housing is assembled and spot-welded to make the apparatus 100. The hinges, feet reinforcements, and lock supports are spot welded in place. After fabrication, the finished apparatus 100 is dipped in rust and corrosion primer, thermally dried, then powder painted with the color coat and thermally cured. This makes a very durable, corrosion and scratch resistant surface. Once the cabinet is complete, the polycarbonate plastic insert is cut on the water jet machining center and installed in the front door of the apparatus 100.

In another embodiment, the display module 102 comprises 18-gauge stainless steel panels that are cut to shape on the water jet-machining center, where all the features are also cut. After cutting, a front surface of the display module 102 is sanded lightly and clear coated. Then the LED lenses are pressed into place and the front panel is screwed to the front of the front door 132. After installation of the display module 102, the commercially available, full color, capacitive touch screen is installed, as is the commercially available payment center in the control module 112. The front door 132 has the assembled transparent window 142 installed and is now ready to be installed on the housing and wiring harness attached before use.

In another embodiment, the cylindrical containers 104 are made from food grade polycarbonate extruded pipe. The 12″ diameter sections are 12″ long. The pipe is indexed forward and turned at a fixed speed below a fixed water jet machining nozzle. After cutting, the cylindrical containers 104 are washed and dried to remove any residue and are adhesively bonded to the dispensing food grade aluminum casting, upon which the food grade gathering and dropping solenoid assembly is attached. The food grade outlet tubing is fabricated from food grade PP (polypropylene) plastic and is adhesively bonded to the PP dropping funnel 110. The dropping funnel is fabricated from food grade 3″ diameter PP tubing. This tubing feeds either into the mixer section or into the heating section 126.

The heating section 126 is made from a food grade stainless steel chamber and fabricated in two sections, which are bolted together using food grade O-rings and stainless-steel fasteners. The lower half of the heating section 126 has a low air volume, quick heating air blower 128. This blower 128 turns on to move the cold nuts into the drop chute (no heat) or to stir the nuts around the heating section 126 using heated air for about 30 seconds until they are raised to 160° F. Then the drop chute opens and they are blown into the mixer section 108.

The mixer section 108 is cylindrically shaped food grade stainless steel chamber is fabricated in two sections, which are bolted together using food grade O-rings and stainless-steel fasteners. The upper section of the mixer section 108 has a ⅜ horsepower gear motor with a food grade fan shaped blade assembly that sweeps the interior of the cylinder, thoroughly mixing the contents, and then forcing them to completely empty into the ‘Nut Mix’ bag 122. The lower section has the filling spout near the rear outer edge of the cylinder. When the solenoid valve 134 opens, the nut mix drops into the bag 122 and any remnants are swept into the drop valve by the mixer blades, insuring a completely clean mixer enclosure for the next cycle. A commercially available bag picker is installed which has an onboard vacuum pump that creates enough vacuum to lift to 5 pounds, which is significantly greater than the bag 122. The picker moves to where the bags 122 are stored, engages and picks up a single bag, and then delivers it to the robotic arm. It repeats this process every time after the filled bag 122 is dropped into the serving receptacle 124.

The robotic gripper and bag placement in the portable snack vending apparatus 100 is constructed using standard off-the-shelf industrial robot components. The robot assembly 120 accepts the bag 122 from the vacuum pick up, opens the top of the bag 122, orients it, and slips it up onto the spout of the mixer section 108. It holds it in place until the thermal sealer 140 robot grips the sealed bottom of the bag 122, holding it in place until the next filling cycle. The robotic assembly 120 and thermal sealer 140 is also constructed using standard off-the-shelf industrial robot components. This robotic assembly 120 is stepped to hold onto the bottom of the bag after it is slipped upon the mixer section 108 spout by the other robot arm. The robot waits until the computer drops the contents of the mixer section 108, lowers the bag 122 to clear the mixing section spout, pulls the bag 122 through the thermal sealer 140, and then moves it toward the front of the apparatus 100, and moves it over the serving receptacle 124 and drops it. Then it moves back to grip the bottom of the next bag 122 placed upon the mixing section spout.

The wiring harness is made on a custom harness board of various gauges of copper stranded wire. The wire is insulated with PVC jacket, which is rated to 600 VAC. The ends of all the wires are inserted into locking plastic connectors with gold plated beryllium copper contacts. The standard thickness, double sided FR4 circuit board material is populated with surface mounted components where possible. Any through-hole devices are inserted after the surface mounted assembly, soldering, and cleaning. All circuit boards are designed to have all the components oriented so they can be mounted with the LED light indicators 130 projecting out through the lenses mounted in the housings. After assembly, the PCBs are protected with a moisture adsorption preventive conformal coating.

The bags 122 used for serving are preprinted, 4 cup maximum, natural paper that has been coated, before folding, on the interior surface with food grade PP (polypropylene) plastic. After folding and thermal sealing, except for the top opening, the bags 122 are compressed to lay flat in the storage and vacuum pick up bins 138. Several hundred bags 122 can be stored in the vacuum pick up area and additional bags 122 could be stored beyond the thermal sealer 140, and later moved into the vacuum pick up area by the service technician. Individual, pre-printed bags 122 are cheaper to purchase than linked and spooled units, while requiring less room to store and move about. Optionally, the bags 122 could be stored on a spool and are inserted onto the mixer section 108 directly from the spool. After filling, the bags 122 are removed from the mixer section 108, run through the thermal sealer 140 to seal the top of the bag 122, after which it is dropped into the serving receptacle 124 by the robotic arm. There could be several spools of bags 122 stored in the apparatus 100, which could be indexed into position using the robotic assembly 120.

In some embodiments, appropriate candies with a high melting point must be selected and supplied by the operator of the apparatus 100. Otherwise, mixing the heated nuts with the candies will cause problems in vending if the candies melt and stick to the internal surfaces of the mixer section 108. It will also be labor intense to clean out the mixer section 108 and chute.

The portable snack vending apparatus 100, according to the present invention, is configured to allow the user to easily buy nuts of their choice and have them served heated, or have them served at room temperature mixed with candy or dried fruit. The display module 102 is transparent so that the user could easily confirm the selected snack with the LED light indicator 130. The apparatus 100 is all weather and could be used outside and also could be shown ready at POS terminals. The control module 112 with the electronic interface 114 allows for easier selection and quick payment process. The heating section 126 is activated with the click of the button to automatically roast the snack 106 selected by the user. The apparatus 100 provides the user with a large selection of choices for a trail mix or nut mix snack 106. The highly visible acrylic cylindrical containers 104 holding fresh nuts and condiments helps the user to make their choice with the visual reference. The control module 112 accepts various modes of payment for convenient transaction. The apparatus 100 could also be tracked remotely for usage, inventory, and sales. The apparatus 100 dispenses measured quantity of the selected snack and packs in the colorful attractive bag 100.

Preferred embodiments of this invention are described herein, including the best mode known to the inventors for carrying out the invention. It should be understood that the illustrated embodiments are exemplary only, and should not be taken as limiting the scope of the invention.

The foregoing examples have been provided merely for the purpose of explanation and are in no way to be construed as limiting of the portable snack vending apparatus 100, disclosed herein. While the portable snack vending apparatus 100 has been described with reference to various embodiments, it is understood that the words, which have been used herein, are words of description and illustration, rather than words of limitation. Further, although the portable snack vending apparatus 100 has been described herein with reference to particular means, materials, and embodiments, the portable snack vending apparatus 100 is not intended to be limited to the particulars disclosed herein; rather, the portable snack vending apparatus 100 extends to all functionally equivalent structures, methods and uses, such as are within the scope of the invention. Although there has been shown and described the preferred embodiment of the present invention, it will be readily apparent to those skilled in the art that modifications may be made thereto.

What is claimed is:

1. A portable snack vending apparatus, comprising:
a display module comprising one or more cylindrical containers positioned in a multi-layered stacked configuration, wherein each container is configured to store a predefined snack and disperse the snack based on a user input to a mixer section via a dropping funnel;
a control module comprising an electronic interface with a microcontroller to receive payment from a user and one or more icons to allow the user to selectively choose the snack from one or more cylindrical containers positioned in the display module, and
a packaging module comprising a robotic assembly configured to wrap and seal the snack from the mixer section in a bag, wherein the wrapped bag is dropped into a serving receptacle.

2. The portable snack vending apparatus of claim 1, wherein the predefined snack is at least one of a peanut, a walnut, a cashew, a hazelnut, a pecan, an almond, a chestnut, a palm nut, a candle nut, a pistachio, a pine nut, a dried fruit, a candy, a sesame stick, a gumdrop, a jelly and a mint.

3. The portable snack vending apparatus of claim 1, wherein the control module comprises a touchscreen display to allow the user to selectively choose the snack from the cylindrical containers positioned in the display module.

4. The portable snack vending apparatus of claim 1, further comprises a heating section configured to selectively heat the predefined snack selected by the user.

5. The portable snack vending apparatus of claim 4, wherein the heating section is configured to selectively roast at least one of the predefined snack.

6. The portable snack vending apparatus of claim 4, wherein the heating section is activated by the user with a click of a button in the control module.

7. The portable snack vending apparatus of claim 4, wherein the heating section further comprises a blower section to selectively roast the predefined snack.

8. The portable snack vending apparatus of claim 1, further comprises a light indicator disposed in each of the cylindrical containers positioned in the display module to visualize the snack selected by the user.

9. The portable snack vending apparatus of claim 1, wherein the cylindrical container is made from a clear acrylic material to visualize the stored predefined snack.

10. The portable snack vending apparatus of claim 1, wherein the cylindrical container is refilled with the predefined snack by unlocking a front door of the display module.

11. The portable snack vending apparatus of claim 1, wherein the electronic interface is configured to receive payment from the user via at least one of a legal tender, a credit card, a debit card, a NFC, a Wi-Fi, a digital payment and a Bluetooth capability.

12. The portable snack vending apparatus of claim 1, wherein the microcontroller is configured to process an input received from the user and activate a solenoid valve based on user input to disperse the predetermined amount of the snack from the cylindrical container to the mixer section.

13. The portable snack vending apparatus of claim 1, wherein the cylindrical container comprises a conical base and a sloping tube section to disperse the snack to the dropping funnel.

14. The portable snack vending apparatus of claim 1, wherein the cylindrical container is made from a food grade polycarbonate material.

15. The portable snack vending apparatus of claim 1, wherein the mixer section is configured to selectively mix at least one of the nut and the condiment based on user's selection from the cylindrical containers positioned in the display module.

16. The portable snack vending apparatus of claim 1, wherein the robotic assembly is configured to retrieve the bag from a storage bin via one or more robotic arms to wrap the predetermined amount of snack from the mixer section.

17. The portable snack vending apparatus of claim 16, wherein the robotic arm is configured to move the wrapped bag through a thermal sealer and drop into the serving receptacle.

18. The portable snack vending apparatus of claim 1, further comprises a transparent window at a bottom section of the serving receptacle.

19. The portable snack vending apparatus of claim 18, wherein the transparent window comprises a spring loaded continuous hinge assembly to automatically close once the bag is retrieved from the serving receptacle.

20. The portable snack vending apparatus of claim 1, comprises a connector assembly to power the apparatus using an external power source.
